(19) United States
(12) Patent Application Publication
(10) Pub. No.: US 2009/0000061 A1
(43) Pub. Date: Jan. 1, 2009

(54) Hinge with a positioning function

(76) Inventors: Ming-Han Lin, Tu-Cheng City (TW); Te-Hung Yin, Tu-Cheng City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/819,347

(22) Filed: Jun. 27, 2007

(51) Int. Cl. E05D 11/10

(52) U.S. Cl. 16/319

(57) ABSTRACT

A hinge with a position function includes a shaft housing and a pivot. The shaft housing has a pivotal portion and a fixed portion extending from one end of the pivotal portion. An opening is defined at the other end of the pivotal portion. At least two recesses extending along an axis of the pivotal portion are defined in the inner surface of the pivotal portion. The pivot has a swiveling member at one end thereof and a peripheral portion at the other end thereof. The swiveling member with at least a couple of locating portions is rotatably inserted into the opening of the pivotal portion, the locating portion is jammed into the recesses for a first location, and can slide out of the recesses and then slide against the inner surface of the pivot for being jammed into the recesses again to achieve a second location by the locating portions shrinking inward.

### BACKGROUND OF THE INVENTION

1. Field of the Invention

The present invention relates to a hinge, and more particularly to a hinge for enabling an electronic device to be positioned in two stable positions.

2. The Related Art

Electronic device such as mobile phone, video camera usually has a plastic top cover for housing or protecting a base. In the previous art, the base is secured to the rear surface of the top cover by a hinge, so that the top cover can pivot about an axis of the base. In the process of pivoting, the hinge can provide a position function to prevent the top cover from being damaged for pivoting with an undue degree.

The above-mentioned hinge with a position function can enable the electronic device to be positioned in two stable positions, but the hinge with a position function has too many components which are complex and high cost. Thus, it would be desirable to provide a new hinge with a position function which overcomes the problems encountered with previous hinge.

### SUMMARY OF THE INVENTION

An object of the present invention is to provide a hinge with a position function including a shaft housing and a pivot fitted in the shaft housing. The shaft housing has a pivotal portion and a fixed portion extending from one end of the pivotal portion. An opening is defined at the other end of the pivotal portion. At least two recesses are defined in the inner surface of the pivotal portion along an axis direction of the pivotal portion and face to each other. The pivot has a swiveling member at one end and a peripheral portion at the other end. A gap is defined in a free end of the swiveling member and extends inward into the inside of the swiveling member along an axis direction thereof, also the gap passes through an outer wall of the swiveling member along a radial direction thereof to divide the swiveling member into two portions. At least a couple of locating portions are fixed to the two portions of the swiveling member respectively and back on to each other.

The swiveling member is rotatably inserted into the opening of the shaft housing with the locating portions jammed into the recesses. The gap can provide an elastic force to assure that the locating portions jam into the recesses to achieve two locations.

Another object of the present invention is to provide a hinge with a position function including a shaft housing and a pivot fitted in the shaft housing. The shaft housing has a pivotal portion and a fixed portion extending from one end of the pivotal portion. An opening is defined at the other end of the pivotal portion. At least two recesses are defined in the inner surface of the pivotal portion along an axis direction of the pivotal portion and face to each other. The pivot has a swiveling member at one end and a peripheral portion at the other end. The swiveling member has an annular structure, a gap defined in the swiveling member and facing the peripheral portion. The gap extends along an axis of the swiveling member and passes through an outer wall and an inner wall and two ends thereof. At least a couple of locating portions are symmetrically defined at two sides of the gap respectively and back on to each other.

Yet another object of the present invention is to provide a hinge with a position function including a shaft housing and a pivot fitted in the shaft housing. The shaft housing has a pivotal portion and a fixed portion extending from one end of the pivotal portion. An opening is defined at the other end of the pivotal portion. At least two recesses are defined in the inner surface of the pivotal portion along an axis direction of the pivotal portion and face to each other. The pivot has a swiveling member at one end and a peripheral portion at the other end. The swiveling member defines a receiving hole passing through two opposite sides of an outer wall thereof along the radial axis thereof. At least a couple of locating portions placed in the receiving hole have an elastic component and a couple of balls abutting against the two extremities of the elastic component.

The swiveling member of the pivot is rotatably inserted into the opening of the shaft housing with the locating portions jammed into the recesses. The elastic component shrinking for receiving a stress can provide an elastic force to assure that the balls jam into the recesses to achieve two locations. The hinge with a position function is of simple and low cost construction.

### BRIEF DESCRIPTION OF THE DRAWINGS

The present invention will be apparent to those skilled in the art by reading the following description of preferred embodiments thereof, with reference to the attached drawings, in which:

FIG. 1 is an exploded view of a first embodiment of a hinge with a position function in accordance with the present invention;

FIG. 2 is a perspective view of the hinge with a position function shown in FIG. 1;

FIG. 3 is a perspective view similar to FIG. 2, but a pivot is rotated a certain degree about a shaft housing;

FIG. 4 is a cross-sectional view of the hinge with a position function, taken along line 4-4 of FIG. 2;

FIG. 5 is a cross-sectional view of the hinge with a position function, taken along line 5-5 of FIG. 3;

FIG. 6 is an exploded view of a second embodiment of the hinge with the position function in accordance with the present invention;

FIG. 7 is a perspective view of the hinge with a position function shown in FIG. 6;

FIG. 8 is a perspective view similar to FIG. 7, but the pivot is rotated a certain degree about the shaft housing;

FIG. 9 is a cross-sectional view of the hinge with a position function, taken along line 9-9 of FIG. 7;

FIG. 10 is a cross-sectional view of the hinge with a position function, taken along line 10-10 of FIG. 8;

FIG. 11 is an exploded view of a third embodiment of the hinge with the position function in accordance with the present invention;

FIG. 12 is a perspective view of the hinge with a position function shown in FIG. 11;

FIG. 13 is a perspective view similar to FIG. 12, but the pivot is rotated a certain degree about the shaft housing;

FIG. 14 is a cross-sectional view of the hinge with a position function, taken along line 14-14 of FIG. 12;

FIG. 15 is a cross-sectional view of the hinge with a position function, taken along line 15-15 of FIG. 13;

FIG. 16 is an exploded view of a fourth embodiment of the hinge with the position function in accordance with the present invention;

FIG. 17 is a perspective view of the hinge with a position function shown in FIG. 16;

FIG. 18 is a perspective view similar to FIG. 17, but the pivot is rotated a certain degree about the shaft housing;

FIG. 19 is a cross-sectional view of the hinge with a position function, taken along line 19-19 of FIG. 17;

FIG. 20 is a cross-sectional view of the hinge with a position function, taken along line 20-20 of FIG. 18;

FIG. 21 is an exploded view of a fifth embodiment of the hinge with the position function in accordance with the present invention;

FIG. 22 is a perspective view of the hinge with a position function shown in FIG. 21;

FIG. 23 is a perspective view similar to FIG. 21, but the pivot is rotated a certain degree about the shaft housing;

FIG. 24 is a cross-sectional view of the hinge with a position function, taken along line 24-24 of FIG. 22; and

FIG. 25 is a cross-sectional view of the hinge with a position function, taken along line 25-25 of FIG. 23.

### DETAILED DESCRIPTION OF THE PREFERRED EMBODIMENT

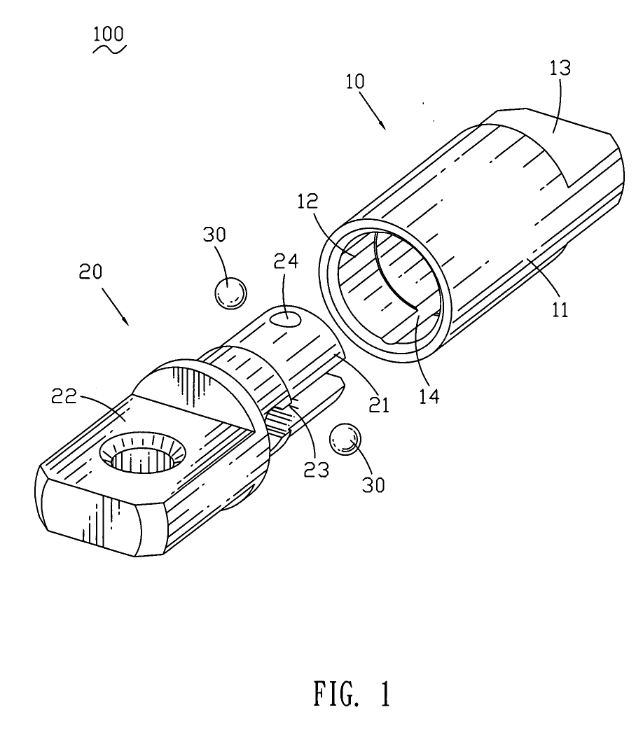

A first embodiment of a hinge with a position function 100 is illustrated in FIGS. 1-5. The hinge with a position function 100 comprises a shaft housing 10 with a columned pivotal portion 11, a pivot 20 and at least a couple of locating portions. The pivotal portion 11 defines an opening 12 extending to the inside at one end thereof. A fixed portion 13 extends outward from the other end of the pivotal portion 11. The fixed portion 13 is largely flat shape, in that the width is more than twice the thickness. Two recesses 14 extending along an axis direction of the pivotal portion 11 are defined in the inner surface of the pivotal portion 11 and face to each other.

The pivot 20 defines a columned swiveling member 21 at one end, and a flat peripheral portion 22 at the other end. The size of the swiveling member 21 is in accordance with the opening 12, so the pivot 20 can be fitted to the shaft housing 10. A gap 23 is defined in a free end of the swiveling member 21 and extends inward into the inside of the swiveling member 21 along an axis direction thereof. Also the gap 23 passes through an outer wall of the swiveling member 21 along a radial direction thereof to divide the swiveling member 21 into two portions. Each portions of the swiveling member 21 has a receiving hole 24 defined in the outer wall. The locating portions are a couple of balls 30.

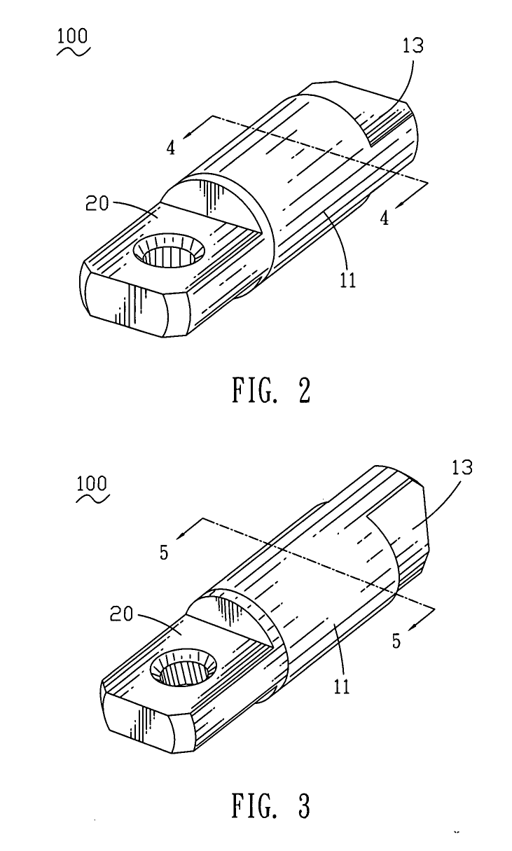

Referring to FIG. 1 and FIG. 2, in assembly, the balls 30 are jammed into the receiving hole 24, then the pivot 20 loaded with the balls 30 is pushed into the shaft housing 10 along the axis thereof. As the gap 23 shrinks, the balls 30 received in the receiving holes 24 abut against the inner surface of the pivotal portion 11. The fixed portion 13 and the peripheral portion 22 are connected to external devices respectively (not shown).

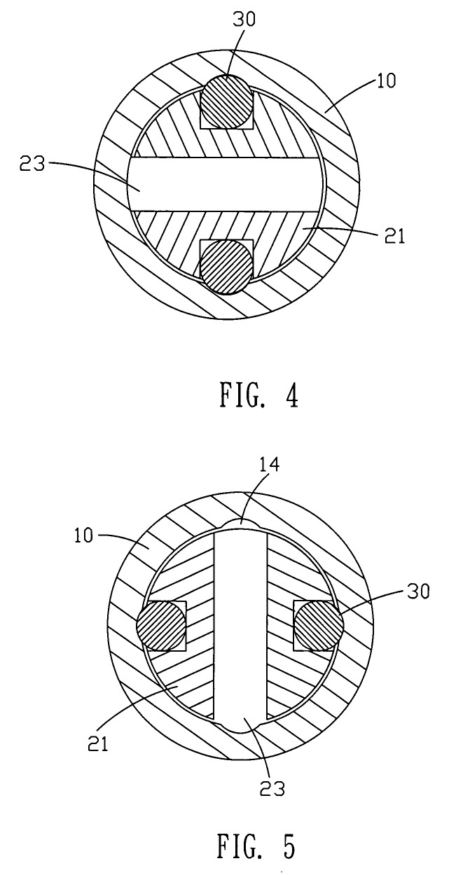

Referring to FIG. 3, FIG. 4 and FIG. 5, in use, the balls 30 slide along the recesses 14 to achieve the first location, then the pivot 20 rotates about the axis of the shaft housing 10 with the balls 30 sliding out of the recesses 14, then the pivot 20 continues to rotate in the same direction until the balls 30 are jammed into the recesses 14 again to achieve the second location after being stapled. In the process of rotating, the gap 23 shrinks to store up the potential energy for providing an elastic force by the balls 30 compressing the swiveling member 21 inward.

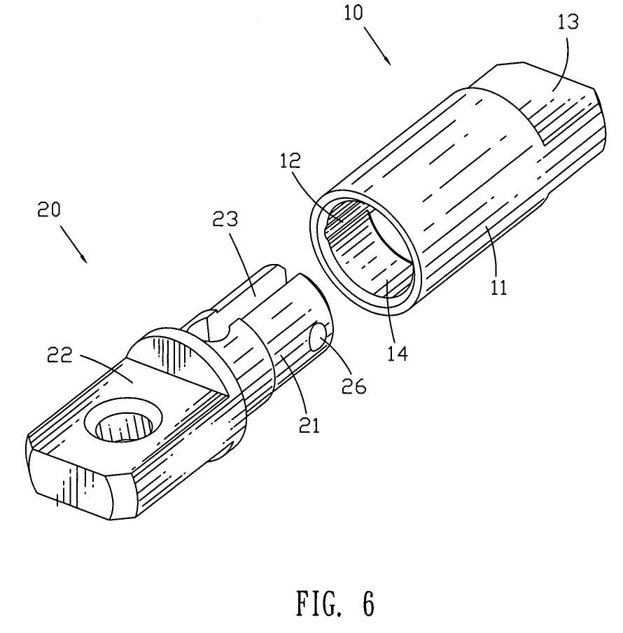

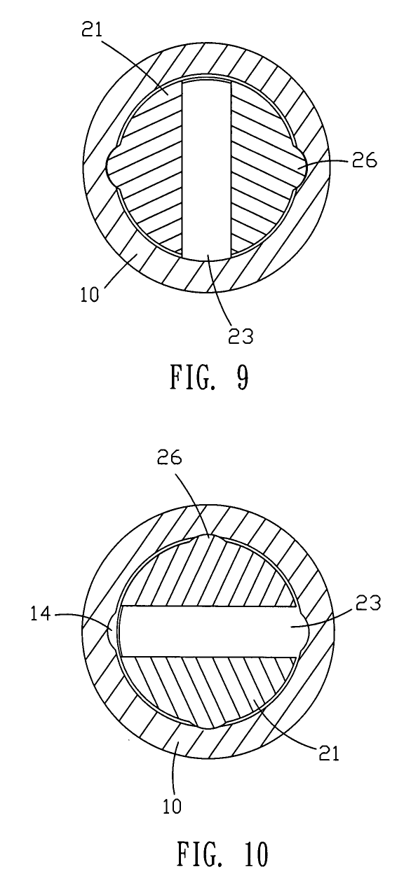

A second embodiment of the hinge with a position function 100 is illustrated in FIGS. 6-10. The hinge in the second embodiment is similar to the hinge in first embodiment. The difference between the second embodiment and the first embodiment is merely that two protrusions 26 as the locating portions have replaced the balls 30 according to the first embodiment and are symmetrically formed on the two portions of the swiveling member 21 divided by the gap 23.

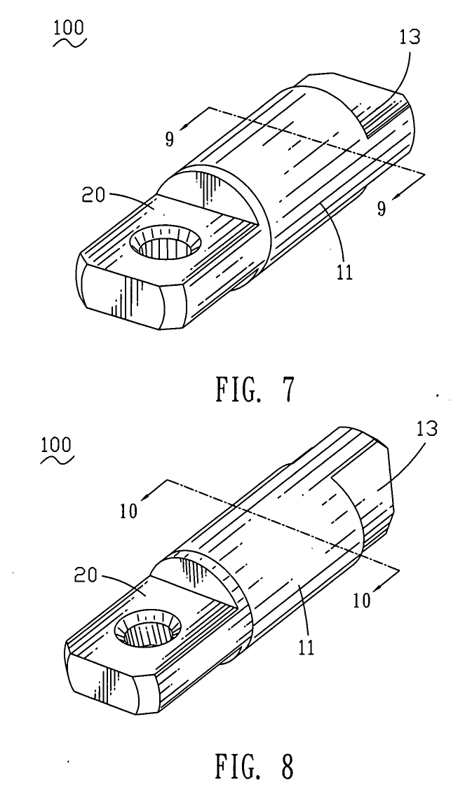

Referring to FIGS. 7-10, in the second embodiment, it is similar to fabricate and use with the first embodiment beside assembly of the balls 30.

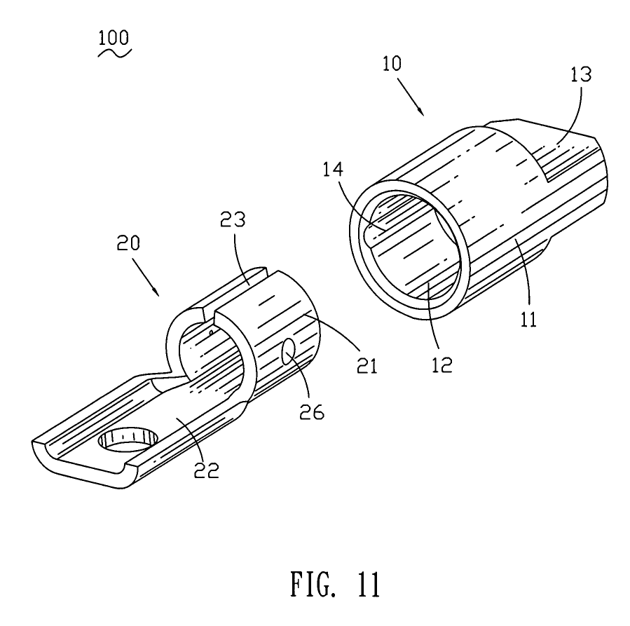

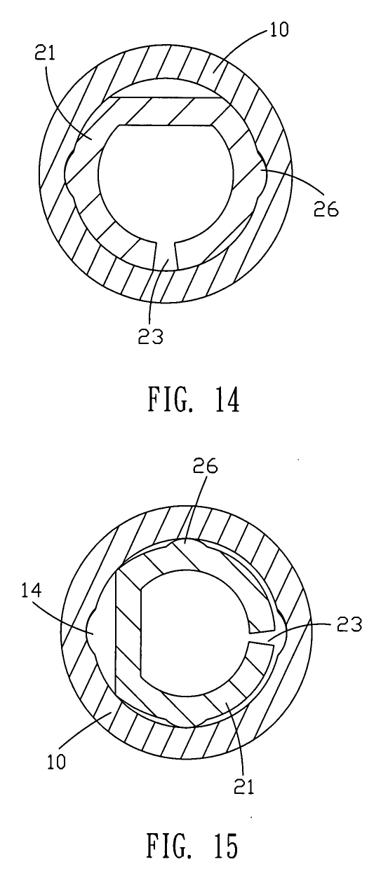

A third embodiment of the hinge with a position function 100 is illustrated in FIGS. 11-15. This hinge in the third embodiment is similar to the hinge in the second embodiment, but the whole structure of the pivot 20 in this embodiment is different from the pivot 20 in the second embodiment. In this embodiment, the swiveling member 21 of the pivot 20 has an annular structure, and the peripheral portion 22 is flat shape. The gap 23 is defined in the swiveling member 21 and faces the peripheral portion 22. The gap 23 extends along an axis of the swiveling member 21 and passes through the two ends thereof, also the gap 23 passes through an outer wall and an inner wall of the swiveling member 21. Two protrusions 26 as the locating portions are symmetrically defined at two sides of the gap 23 respectively. When the swiveling member 21 is inserted into the pivotal portion 11, the swiveling member 21 is deformed by an elastic force with which the pivotal portion 11 provides. The gap 23 begins to shrink the width thereof (shown in FIGS. 13-14) so that the protrusions 26 can be jammed into the recesses 14 firmly.

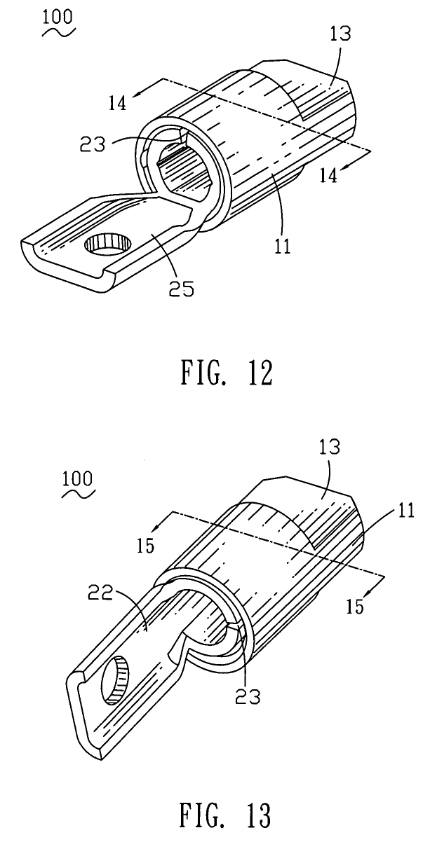

Referring to FIGS. 12-15, in the third embodiment, it is similar to fabricate and use with the second embodiment.

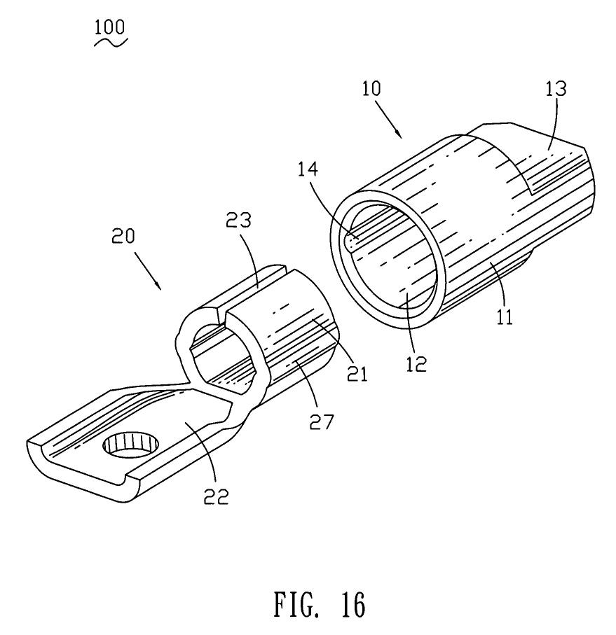

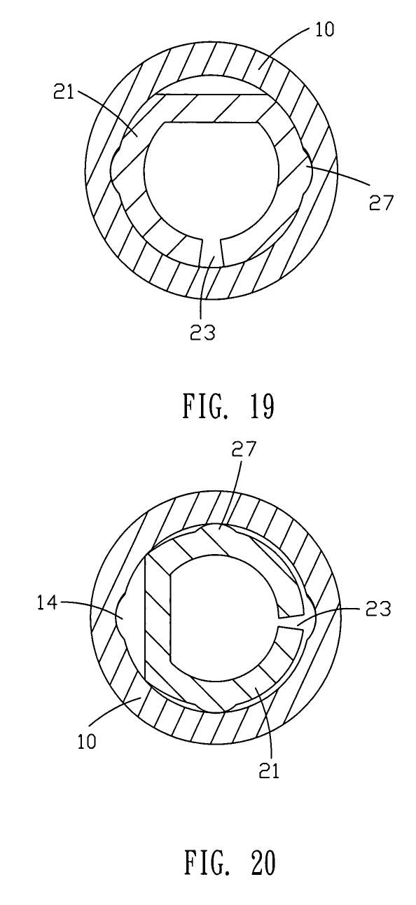

A fourth embodiment of the hinge with a position function 100 is illustrated in FIGS. 16-20. This hinge is similar to the third embodiment. The difference between them is merely that two protruding ribs 27 extending along an axis of a swiveling member 21 are symmetrically formed at two sides of the gap 23 in this embodiment for replacing the protrusions 26 to realize the function of the locating portions.

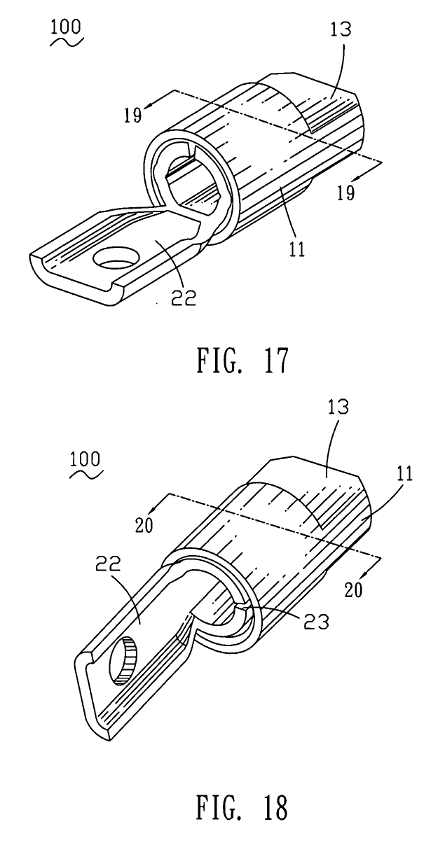

Referring to FIGS. 17-20, in the fourth embodiment, it is similar to fabricate and use with the third embodiment.

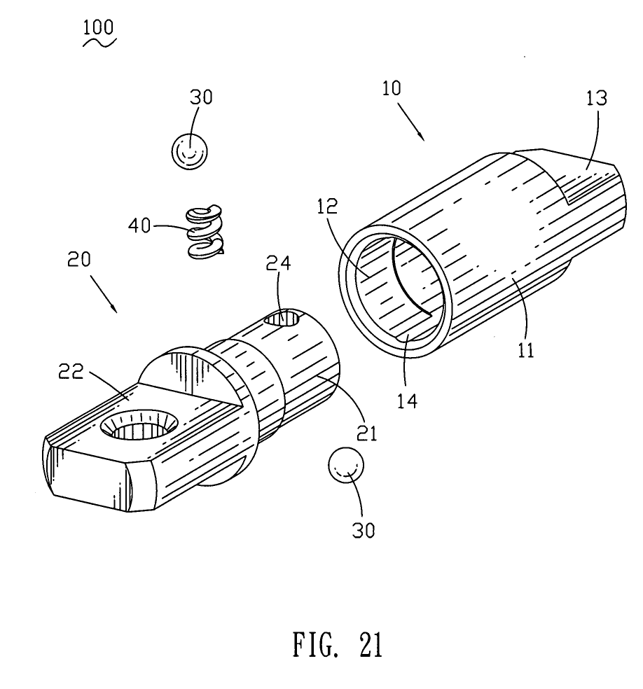

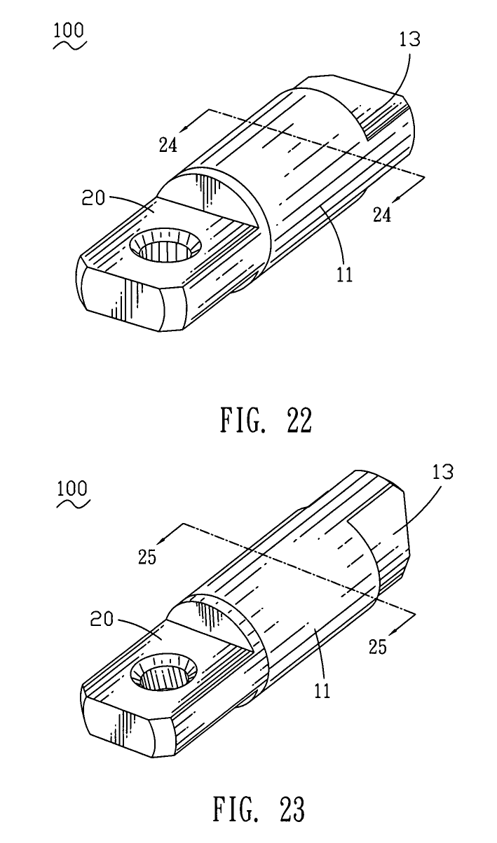

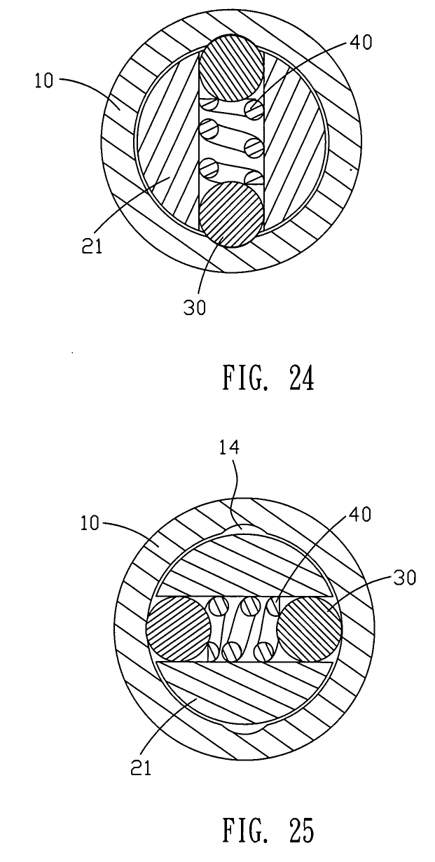

A fifth embodiment of the hinge with a position function 100 is illustrated in FIGS. 21-25. The fifth embodiment is similar to the first embodiment, the difference between them is merely that the swiveling member 21 in this embodiment isn't hollow and the receiving hole 24 passing through two opposite sides of the outer wall of the swiveling member 21 along the radial axis thereof to replace the gap 23, moreover the locating portions in this embodiment further comprises a spring 40.

Referring to FIGS. 21-23, in assembly, the spring 40 is placed in the receiving hole 24, and then the two balls 30 are configured in the receiving hole 24 to abut against the two extremities of the spring 40, the swiveling member 21 loaded with the spring 40 and the balls 30 is pushed into the shaft housing 10 along an axis thereof after being stapled. The spring 40 shrinks to save the potential energy for the compression of the balls 30 by the inner surface of the pivotal portion 11.

Referring to FIGS. 23-25, in the fifth embodiment, it is similar to use with the first embodiment. The pivot 20 rotates to achieve two times locations. In the process of rotating, the spring 40 shrinks to save the potential energy for providing an elastic force, and the swiveling member 21 isn't deformed from first to last.

As described above, the recesses 14 extending along the axis of the shaft housing 10 are defined in the inner surface of the shaft housing 10. Either the gap formed through the swiveling member 21 or the spring 40 received in the receiving holes 24 can provide an elastic force to make the locating portions jam into the recesses 14. The design of the invention can achieve twice locations with simple structure. The foregoing disclosure and description of the invention are illustrative and explanatory thereof, and various changes may be made without departing from the spirit of the invention.

What is claimed is:

1. A hinge with a position function, comprising:
a shaft housing having a pivotal portion and a fixed portion extending from one end of the pivotal portion, an opening defined at the other end of the pivotal portion, at least two recesses defined in the inner surface of the pivotal portion along an axis direction of the pivotal portion and facing to each other; and
a pivot fitted in the shaft housing having a swiveling member at one end and a peripheral portion at the other end, a gap defined in a free end of the swiveling member and extending inward into the inside of the swiveling member along an axis direction thereof, also the gap passing through an outer wall of the swiveling member along a radial direction thereof to divide the swiveling member into two portions;
at least a couple of locating portions fixed to the two portions of the swiveling member respectively and backing on to each other;
wherein said swiveling member of the pivot is rotatably inserted into the opening of the shaft housing, said locating portions jammed into the recesses.

2. The hinge with a position function as claimed in claim 1, wherein the two portions of the swiveling member have a receiving hole defined in the outer wall respectively for receiving a couple of balls performing as said locating portions.

3. The hinge with a position function as claimed in claim 1, wherein the locating portions are a couple of protrusions symmetrically formed on the two portions of the swiveling member.

4. The hinge with a position function as claimed in claim 1, wherein the locating portions are a couple of protuberance ribs extending along an axis of a swiveling member and symmetrically formed on the two portions of the swiveling member.

5. A hinge with a position function, comprising:
a shaft housing having a pivotal portion and a fixed portion extending from one end of the pivotal portion, an opening defined at the other end of the pivotal portion, at least two recesses defined in the inner surface of the pivotal portion along an axis direction of the pivotal portion and facing to each other;
a pivot fitted in the shaft housing having a swiveling member at one end and a peripheral portion at the other end, the swiveling member having an annular structure, a gap defined in the swiveling member and facing the peripheral portion, the gap extending along an axis of the swiveling member and passing through an outer wall and an inner wall and two ends thereof; and
at least a couple of locating portions symmetrically defined at two sides of the gap respectively and backing on to each other;
wherein said swiveling member of the pivot is rotatably inserted into the opening of the shaft housing, said locating portions are jammed into the recesses.

6. The hinge with a position function as claimed in claim 5, wherein the locating portions are a couple of protrusions symmetrically formed on the two portions of the swiveling member.

7. The hinge with a position function as claimed in claim 5, wherein the locating portions are a couple of protuberance ribs extending along an axis of a swiveling member and symmetrically formed on the two portions of the swiveling member.

8. A hinge with a position function, comprising:
a shaft housing having a pivotal portion and a fixed portion extending from one end of the pivotal portion, an opening defined at the other end of the pivotal portion, at least two recesses defined in the inner surface of the pivotal portion along an axis direction of the pivotal portion and facing to each other; and
a pivot fitted in the shaft housing having a swiveling member at one end and a peripheral portion at the other end, the swiveling member defining a receiving hole passing through two opposite sides of an outer wall thereof along the radial axis thereof;
at least a couple of locating portions placed in the receiving hole and having an elastic component and a couple of balls abutting against the two extremities of the elastic component;
wherein said swiveling member of the pivot is rotatably inserted into the opening of the shaft housing, said locating portions are jammed into the recesses.

9. The hinge with a position function as claimed in claim 8, wherein the elastic component is a spring.
